(19) United States
(12) Patent Application Publication
(10) Pub. No.: US 2016/0117897 A1
(43) Pub. Date: Apr. 28, 2016

(54) MERCHANDISE DISPLAY HOOK ALARM

(71) Applicant: INVUE SECURITY PRODUCTS INC., Charlotte, NC (US)

(72) Inventors: Jeffrey A. Grant, Charlotte, NC (US); Gary A. Taylor, Fort Mill, SC (US); David N. Berglund, Charlotte, NC (US)

(73) Assignee: inVue Secruity Products Inc., Charlotte, NC (US)

(21) Appl. No.: 14/895,538

(22) PCT Filed: Jun. 11, 2014
(86) PCT No.: PCT/US2014/041870

§ 371 Date: Dec. 3, 2015

Related U.S. Application Data
(60) Provisional application No. 61/834,156, filed on Jun. 12, 2013.

(51) Int. Cl. G08B 13/06; A47F 5/00

(52) U.S. Cl. CPC G08B 13/06; A47F 5/0006

(57) ABSTRACT

Display hook alarms for securing items of merchandise from theft are provided. For example, the display hook alarm includes a housing configured to at least partially receive at least one rod and to be releasably secured to the at least one rod. The display hook alarm also includes an alarm mechanism configured to generate at least one alarming signal when the housing is removed from the at least one rod in an unauthorized manner.

### CROSS REFERENCE TO RELATED APPLICATIONS

This application claims the benefit of priority to U.S. Provisional Application No. 61/834,156 filed on Jun. 12, 2013, the entire disclosure of which is incorporated herein by reference.

### BACKGROUND OF THE INVENTION

Embodiments of the present invention relate generally to a merchandise display hook alarm for items of merchandise.

It is common practice for retailers to display items of merchandise on a security device, such as a display hook or a display fixture. The security device displays an item of merchandise so that a potential purchaser may examine the item when deciding whether to purchase the item. The small size and relative expense of the item, however, makes the item an attractive target for shoplifters. A shoplifter may attempt to detach the item from the security device, or alternatively, may attempt to remove the security device from the display area along with the merchandise.

### BRIEF SUMMARY

Embodiments of the present invention are directed to display hook alarms. In one embodiment, a display hook alarm for cooperating with at least one rod for supporting and displaying items of merchandise is provided. The display hook alarm includes a housing configured to at least partially receive at least one rod and to be releasably secured to the at least one rod. The display hook alarm also includes an alarm mechanism configured to generate at least one alarming signal when the housing is removed from the at least one rod in an unauthorized manner.

In another embodiment, a display hook alarm for cooperating with at least one rod for supporting and displaying items of merchandise is provided. In this embodiment, the display hook alarm includes a housing configured to at least partially receive at least one rod and to be releasably secured to the at least one rod and a tilt sensor configured to detect a change in orientation of the at least one rod and/or the housing. The display hook alarm also includes an alarm mechanism configured to generate at least one alarming signal in response to a change in orientation of the at least one rod and/or the housing.

According to another embodiment, a display hook system is provided. The display hook system includes at least one rod for supporting a plurality of items of merchandise thereon and a display hook alarm configured to at least partially receive the at least one rod and to be releasably secured to the at least one rod. The display hook alarm comprises an alarm mechanism configured to generate at least one alarming signal when the display hook alarm is removed from the at least one rod in an unauthorized manner.

In one embodiment, a method for protecting items of merchandise from theft is provided. The method includes securing at least one rod to a display support, wherein the at least one rod is configured to support a plurality of items of merchandise. The method further includes releasably securing a display hook alarm to the at least one rod, wherein the display hook alarm comprises an alarm mechanism configured to generate at least one alarming signal when the display hook alarm is removed from the at least one rod in an unauthorized manner.

### BRIEF DESCRIPTION OF THE DRAWINGS

FIG. 1 is a perspective view of a display hook alarm supported on a rod extending from a display support according to one embodiment of the present invention.

FIG. 2 is an enlarged perspective view of the display hook alarm shown in FIG. 1 locked to the rod.

FIG. 3 is a front perspective view of the display hook alarm shown in FIG. 2.

FIG. 4 is a perspective view of the display hook alarm shown in FIG. 1 communicating with a key according to one embodiment of the present invention.

FIG. 5 is a perspective view of the display hook alarm shown in FIG. 1 in an unlocked configuration.

FIG. 6 is an elevation view of the display hook alarm shown in FIG. 1 removed from the rod and in an unlocked configuration.

FIG. 7 is a perspective view of a display hook alarm operably engaged with a sensor according to one embodiment of the present invention.

FIG. 8 is a perspective view of the display hook alarm shown in FIG. 7 supported on a rod and the sensor shown in FIG. 7 attached to an item of merchandise according to one embodiment of the present invention.

FIG. 9 is a perspective view of a sensor according to an embodiment of the present invention.

FIG. 10 is a schematic of a display hook alarm according to one embodiment of the present invention.

### DETAILED DESCRIPTION OF THE INVENTION

Embodiments of the present invention will now be described more fully hereinafter with reference to the accompanying drawings, in which exemplary embodiments of the invention are shown. This invention may, however, be embodied in many different forms and should not be construed as limited to the embodiments set forth herein. Rather, the exemplary embodiments are provided so that this disclosure will be thorough and complete, and will fully convey the scope of the invention to those skilled in the art.

Referring now to the accompanying drawing figures, one or more embodiments of a display hook alarm 10 are shown. The display hook alarm 10 may be employed with display hooks 12 of the type commonly used to display one or more items of merchandise “M” within a display area of a retail store. By way of example, and not by limitation, the display hook 12 may be a merchandise display hook for displaying relatively, small, expensive consumer products, for example compact discs (CDs), digital video discs (DVDs), battery packs, electronic devices, etc., on a display support 14. The display support 14 could be any suitable support, such as wire grid, horizontal bar rack, slatwall (also known as slatboard), wall, table, desk, countertop or other secure structure. Other examples of a display hook 12 according to the present invention without limitation include merchandise display fixtures. In some example embodiments, the display hooks 12 are similar to the locking hooks and flexible looking hooks manufactured by InVue Security Products Inc.

In one embodiment, the display hook 12 includes at least one rod configured to engage and extend outwardly from a display support. For example, the display hook may include a pair of rods 16, 18 as shown in FIG. 1. The rod 16 or 18 may be a generally straight member in some embodiments. The rod 16 or 18 may extend substantially perpendicular relative to a display support 14 when supported on the display support. In some embodiments, the display hook 12 is configured to engage and be supported by the display support 14. In other embodiments, the display hook 12 is configured to lock to the display support 14 such that the display hook may not be removed from the display support without the use of a key 20, such as with a mechanical and/or an electronic key. In this regard, the display hook 12 may include a base assembly 22 that is configured to engage the display support. According to some embodiments, a lockable base assembly suitable for use with the display hook 12 is shown and described in U.S. Pat. No. 8,341,987 entitled SECURITY DEVICE FOR ATTACHING A PEG HOOK To A PEG SUPPORT, the entire disclosure of which is incorporated herein by reference.

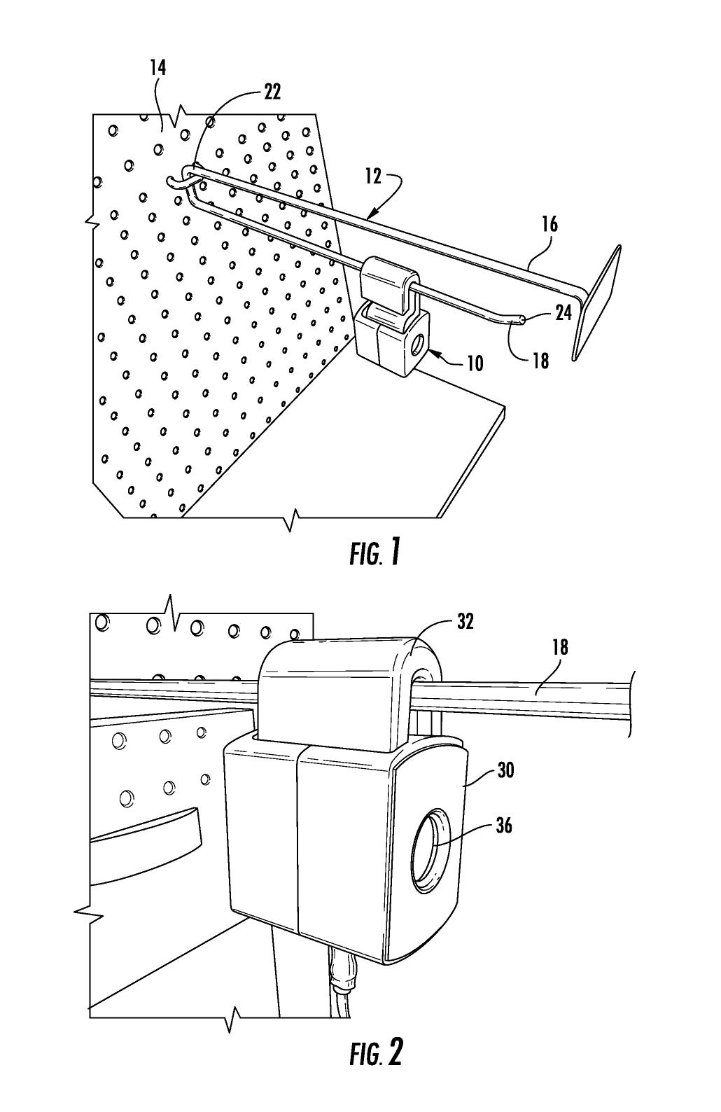

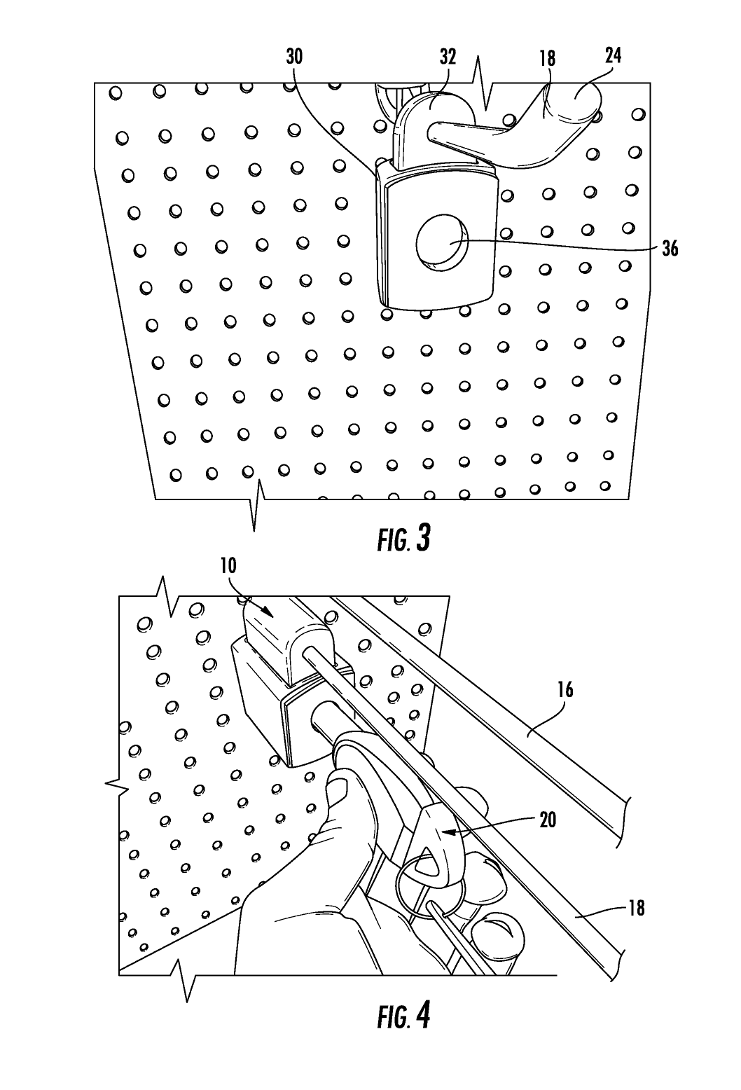

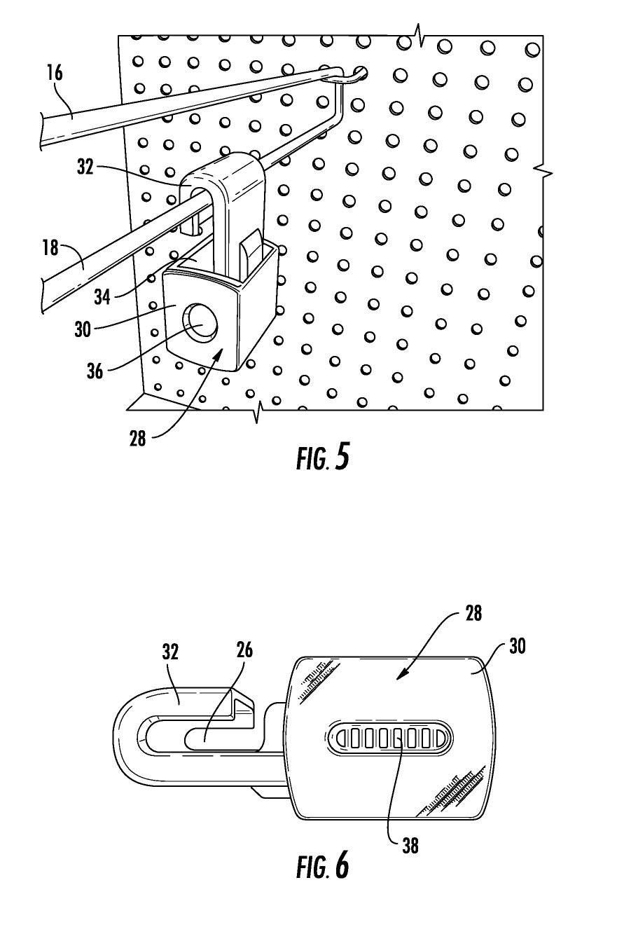

In one embodiment, a display hook alarm 10 is configured to be secured to at least one rod 16 or 18 (see, e.g., FIGS. 1-5 and 8). It is understood that the display hook alarm 10 may be coupled to the rod 16 or 18 at any desirable location thereon, such as at a free end 24 of the rod, proximate the free end of the rod, or spaced away from the free end of the rod towards the opposite end of the rod. For instance, the display hook alarm 10 could be spaced a distance from the free end 24 of the rod 16 or 18. Furthermore, the display hook alarm 10 may be configured to slide along the rod 16 or 18 in a locked configuration. A bend at a free end 24 of the rod 16 or 18 may prevent the display hook alarm 10 from sliding off of the rod without first unlocking the display hook alarm. For example, the display hook alarm 10 may include an opening 26 (see, e.g., FIG. 6) that at least partially surrounds the rod 16 or 18 and is sized such that when the display hook alarm abuts the bend, the display hook alarm is unable to move past the bend. The display hook alarm 10 may be secured to the rod(s) 16 or 18 such that items of merchandise M may be not removed without first unlocking and/or disarming the display hook alarm with a key 20. In some embodiments, the display hook alarm 10 is similar in construction to those manufactured by InVue Security Products, Inc., such as the Stoplok, while the key may be similar to the IR, IR2, and IR2-S keys, also manufactured by InVue Security Products, Inc.

The rod 16 or 18 of the display hook 12 may have a bend or a series of bends at its free end 24 to define an optional anti-sweeping feature. The anti-sweeping feature is designed to increase the amount of time required to remove an item of merchandise M from the display hook 12, and in some instances, permits only one item of merchandise to be removed at a time. Thus, the anti-sweeping feature may prevent a shoplifter from removing all of the items of merchandise M from the display hook 12 at one time, referred to in the art as “sweeping.” A bend at the free end 24 of the rod 16 or 18 may also facilitate engagement with the display hook alarm 10, as discussed above.

FIGS. 1-9 illustrate various embodiments of a display hook alarm 10. In this regard, the display hook alarm 10 generally includes a housing 28 configured to be secured to the rod 16 or 18. The housing 28 may include a body member 30 and a hook member 32 configured to engage the body member. The hook member 32 may be configured to at least partially surround the rod 16 or 18 such that the display hook alarm 10 may hang on the rod. The hook member 32 may include an opening 26 defined therethrough that is configured to receive the rod 16 or 18. The opening 26 may be sized to as to allow the hook member 32 to slide along the rod 16 or 18. However, it is understood that the hook member 32 may be fixed to the rod 16 or 18 in a locked configuration whereby the display hook alarm 10 is unable to slide along the rod. The hook member 32 is shown as having a generally “U-shaped” member, although other shapes may be employed.

In addition, the hook member 32 may be configured to engage the body member 30. The hook member 32 may mechanically and/or electrically engage or lock to the body member 30. In this regard, the hook member 32 may include a locking mechanism 35 that cooperates with the body member 30 to prevent the hook member from disengaging the body member without being unlocked. The body member 30 may include a slot 34 or receiving member configured to receive a portion of the hook member 32 thereby closing the hook member about the rod. The hook member 32 may be unlocked from the body member 30 using various techniques. In one embodiment, the display hook alarm 10 may include a latch 38 that is configured to disengage the hook member 32 from the body member 30. Thus, actuation of the latch 38 disengages the locking mechanism 35 and allows the hook member 32 to be retracted relative to the body member 30. It is understood that various locking mechanisms 35 could be employed, whether operably engaged with the body member 30 and/or the hook member 32 for locking the hook member to the body member. For example, various mechanical and/or electronic mechanisms may be used to lock or otherwise engage the body member 30 and the hook member 32.

In one embodiment, the display hook alarm 10 includes an alarm mechanism 37. The alarm mechanism 37 is configured to generate a perceptible alarming signal (e.g., an audible, a visible, and/or haptic signal). For example, the alarm mechanism 37 may be operably engaged with the display hook alarm 10 and be configured to generate an alarming signal when the display hook alarm is removed from the rod 16 or 18 in an unauthorized manner. It is understood that the alarming signal may be any suitable audible, visual, and/or haptic signal. For example, the alarming signal may be a “beep”, alarm, siren, or the like with any desired duration and pattern. Likewise, a visual signal may be any suitable lighting, flashing, LED indictor, or the like. In addition, an example haptic signal may be a vibration signal that is generated as the item of merchandise M is being removed and that is perceptible to the customer.

The alarm mechanism 37 may be disarmed with a key 20 or after a predetermined period of time for generating an alarming signal has elapsed. The key 20 may be the same key used to lock/unlock the display hook 12 from the display support 14, or a separate key may be utilized. Such a key 20 may utilize mechanical and/or electronic functionality and may be configured to be actuated with an actuator (e.g., a push button). In one embodiment, the key 20 may utilize wireless signals, such as infrared signals, to communicate with the alarm mechanism 37 or display hook 12 to arm or disarm the alarm mechanism. The display alarm hook 10 may include a port 36, window, or the like for interfacing with the key, such as via wireless communication. The key 20 may also be configured to transmit a specific security code for arming or disarming the alarm mechanism 37. In one example, the key 20 may utilize similar features as that disclosed by U.S. Pat. No. 7,737,845, entitled PROGRAMMABLE KEY FOR SECURITY SYSTEM FOR PROTECTING MERCHANDISE, the contents of which are hereby incorporated by referenced in its entirety.

In one embodiment, the hook member 32 may be disengaged with the body member 30 without the need for a key 20. For example, actuation of the latch 38 could be used to disengage the hook member 32 from the body member 30. Upon disengagement of the hook member 32, the alarm mechanism 37 may generate an alarming signal. A key 20 would then be required in order to disarm the alarm mechanism 37. Thus, in some embodiments, the latch 38 may be used to disengage the hook alarm 10 from the rod 16 or 18 without first unlocking a lock mechanism and/or disarming an alarm mechanism 37. However, a key 20 may be required in some embodiments, such as to disengage a locking mechanism 35. In addition, the key 20 may be used that both unlocks the hook member 32 from the body member 30 and disarms the alarm mechanism 37.

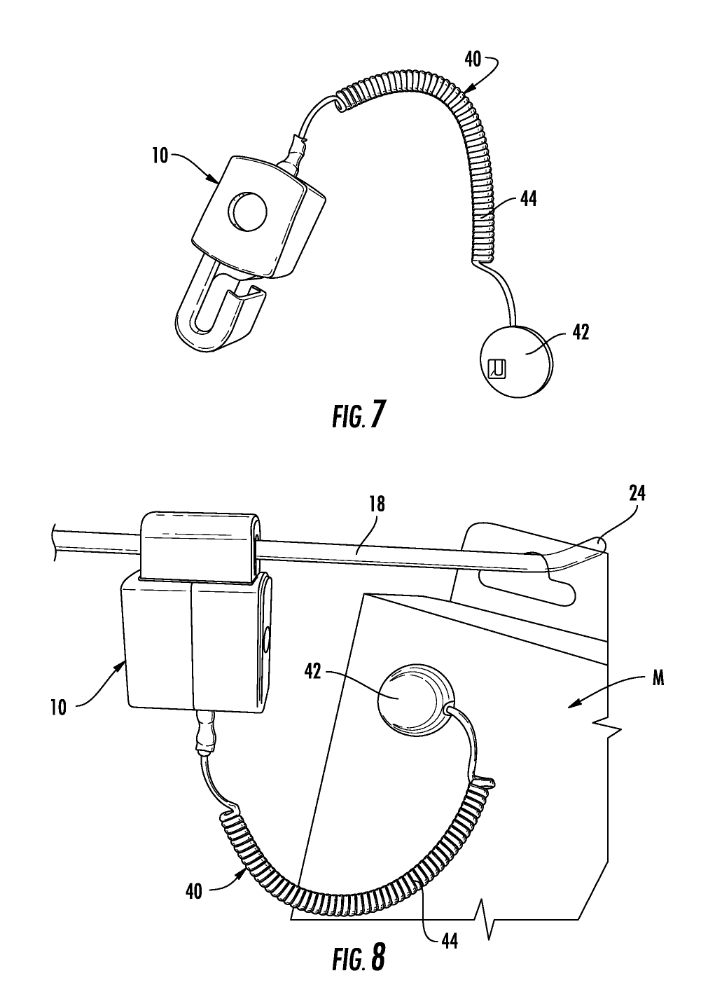

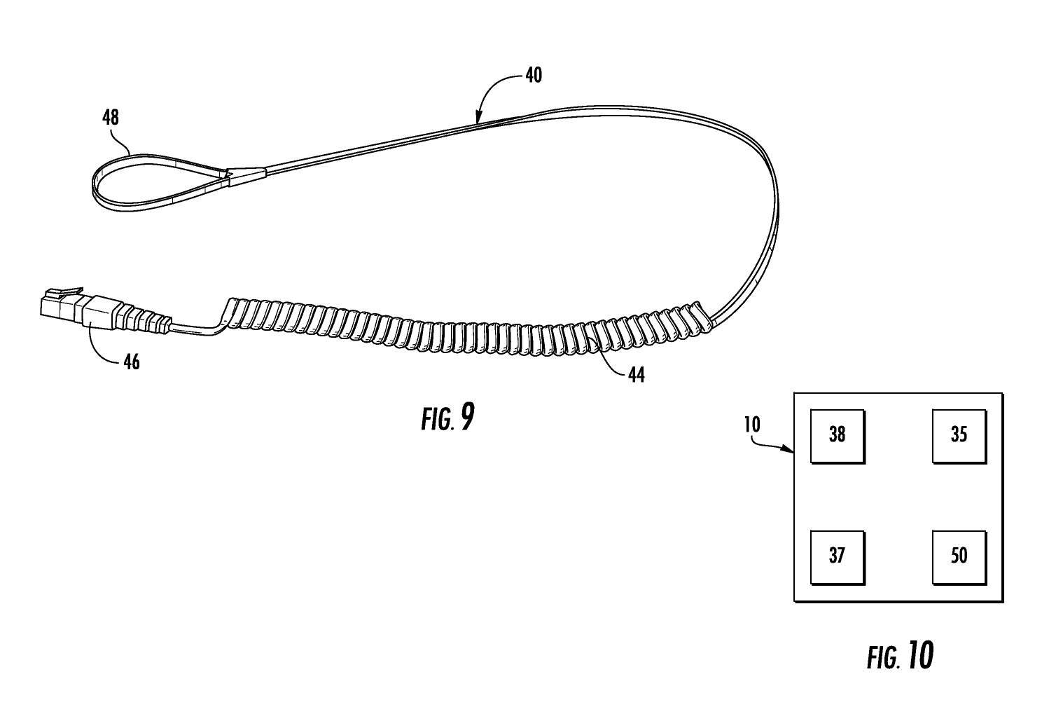

FIGS. 7 and 8 illustrate that the display hook alarm 10 may include additional sensors 40 or devices for further security enhancements or retail display options. In this regard, the display hook alarm 10 may include a secondary sensor 42 that is configured to be affixed to an item of merchandise M. The item of merchandise M could then be disposed on the rod 16 or 18 such that a customer may interact with the merchandise. Should the customer desire to purchase the item of merchandise M, authorized personnel could then use a key 20 to unlock and/or disarm the display hook alarm 10 in order to remove another item of merchandise to be purchased. The secondary sensor 42 may include a pressure sensitive adhesive or the like that is configured to secure the sensor to the item of merchandise M. The secondary sensor 42 may further include a cable 44 with a connector 46 at an end thereof that is configured to engage the housing 28. Moreover, the secondary sensor 42 may include a pressure or plunger switch that is configured to engage the item of merchandise M when attached thereto. Thus, the secondary sensor 42 is configured to be in electrical communication with the display hook alarm 10. Should the cable 44 be cut, the connector 46 removed from the display hook alarm, or the sensor 42 removed from the merchandise, the alarm mechanism 37 may be configured to generate an alarming signal. FIG. 9 illustrates another example where the end of the cable 44 may include a noose 48 such that the cable may be looped through an opening in an item of merchandise M and through the opening of the noose. The connector 46 on the end of the cable 44 may then be operably engaged with the display hook alarm 10 such that cutting the cable or removing the connector results in the generation of an alarming signal.

In another embodiment, FIG. 10 illustrates various components of the display hook alarm, which may include the aforementioned locking mechanism 35, alarm mechanism 37, and latch 38, and which may be configured to communicate or otherwise cooperate with one another. FIG. 10 also shows that the display hook alarm 10 may include a tilt sensor 50. The tilt sensor 50 may be configured to detect a change in orientation of the display hook alarm 10 that is indicative of unauthorized removal of the display hook alarm from the rod 16 or 18 and/or removal of the display hook from the display support 14. As such, the tilt sensor 50 may be configured to detect a change in orientation about one or more axes (e.g., a pitch, roll, or yaw axis relative to the rod 16 or 18 or display hook alarm 10). For example, the tilt sensor 50 may be configured to detect a change in orientation or pitch when the rod 16 or 18 is tilted relative to the display support 14 which may be indicative of a potential thief attempting to remove the rod 16 or 18 from the display support 14. However, the tilt sensor 50 may not be configured to detect pivoting of the display hook alarm 10 relative to the rod 16 or 18 (e.g., roll or yaw), which may be indicative of a potential customer handling the display hook alarm or items of merchandise M. Various tilt sensors 50 or means may be utilized for detecting tilt, such as an accelerometer. The tilt sensor 50 may be in communication with the alarm mechanism 37 such that the alarm mechanism may be configured to generate an alarming signal in the event that the tilt changes at all, or changes more than a predetermined threshold. The tilt sensor 50 may be operably engaged with the hook member 32 and/or the body member 30. For example, the tilt sensor 50 may be housed within the body member 30.

The foregoing has described one or more embodiments of a display hook alarm of the type commonly used to secure items of merchandise from theft. Embodiments of a display hook alarm have been shown and described herein for purposes of illustration. Those of ordinary skill in the art, however, will readily understand and appreciate that numerous variations and modifications of the invention may be made without departing from the spirit and scope of the invention.

1. A display hook alarm for cooperating with at least one rod for supporting and displaying items of merchandise, the display hook alarm comprising:
a housing configured to at least partially receive at least one rod and to be releasably secured to the at least one rod; and
an alarm mechanism configured to generate at least one alarming signal when the housing is removed from the at least one rod in an unauthorized manner.

2. The display hook alarm of claim 1, wherein the housing comprises a locking mechanism for locking the housing to the at least one rod

3. The display hook alarm of claim 2, further comprising a latch configured to disengage the locking mechanism.

4. The display hook alarm of claim 1, wherein the housing is configured to receive a wireless security signal from a key for arming and/or disarming the alarm mechanism.

5. The display hook alarm of claim 4, wherein the housing comprises a port configured to wirelessly communicate with the key.

6. The display hook alarm of claim 1, further comprising a tilt sensor configured to detect a change in orientation of the at least one rod and/or the housing.

7. The display hook alarm of claim 1, wherein the alarming signal comprises an audible signal.

8. The display hook alarm of claim 1, further comprising a secondary sensor in operable engagement with the alarm mechanism.

9. The display hook alarm of claim 8, wherein the secondary sensor comprises a cable configured to releasably engage the housing and a sensor configured to be secured to an item of merchandise.

10. The locking hook of claim 1, wherein the housing comprises a hook member configured to at least partially receive the at least one rod and a body member configured to engage the hook member such that the body member and the hook member are releasably secured to the at least one rod.

11. The locking hook of claim 10, wherein the hook member and the body member are configured to slide relative to the rod when the hook member is engaged with the body member.

12. The locking hook of claim 10, wherein the hook member is configured to lock to the body member via a locking mechanism.

13. The display hook alarm of claim 10, wherein the body member comprises a slot configured to receive a portion of the hook member therein for securing the body member and the hook member to the rod.

14. The display hook alarm of claim 10, wherein the hook member defines an opening configured to receive the at least one rod therethrough.

15. (canceled)

16. A display hook system for protecting items of merchandise from theft, the system comprising:
at least one rod for supporting a plurality of items of merchandise thereon; and
a display hook alarm configured to at least partially receive the at least one rod and to be releasably secured to the at least one rod, wherein the display hook alarm comprises an alarm mechanism configured to generate at least one alarming signal when the display hook alarm is removed from the at least one rod in an unauthorized manner.

17. The display hook system of claim 16, further comprising a key configured to communicate with the alarm mechanism for arming and/or disarming the alarm mechanism.

18. A method for protecting items of merchandise from theft, the method comprising:
securing at least one rod to a display support, the at least one rod configured to support a plurality of items of merchandise; and
releasably securing a display hook alarm to the at least one rod, wherein the display hook alarm comprises an alarm mechanism configured to generate at least one alarming signal when the display hook alarm is removed from the at least one rod in an unauthorized manner.

19. The method of claim 18, wherein releasably securing comprises positioning a hook member about the at least one rod and engaging the hook member with a body member such that the body member and the hook member are releasably secured to the at least one rod.

20. The method of claim 18, further comprising actuating a key for communicating with the display hook alarm for arming and/or disarming the display hook alarm.

21. The display hook alarm of claim 6, wherein the alarm mechanism is configured to generate at least one alarming signal in response to a change in orientation of the at least one rod and/or the housing.
